(19) United States
(12) Patent Application Publication
(10) Pub. No.: US 2003/0069115 A1
(43) Pub. Date: Apr. 10, 2003

(54) Processing center

(76) Inventors: Rolf Binder, Monchengladbach (DE); Fritz Duerler, Siegen-Eisern (DE)

Correspondence Address: MARTIN FLEIT, FLEIT KAIN GIBBONS GUTMAN & BONGINI, 520 BRICKELL KEY DRIVE #A201, MIAMI, FL, 33131, US

(21) Appl. No.: 10/233,317

(22) Filed: Aug. 29, 2002

(30) Foreign Application Priority Data
Sep. 11, 2001 (DE) 101 44 679.9

(51) Int. Cl. B23Q 3/157

(52) U.S. Cl. 483/36

(57) ABSTRACT

A processing center for round workpieces with a machine bed, a horizontal main driving spindle with a workpiece chuck which is rotationally supported on the machine bed in a lateral headstock and rotationally driven by a drive, a tailstock that is arranged on the machine bed and a support that is displaceably arranged on the machine bed. The support contains a table saddle that can be displaced on the machine bed and an upper headstock that is obliquely arranged on the table saddle and contains a carrier that can be displaced along the longitudinal axis of the upper headstock. Exchangeable processing units for carrying out different processing technologies can be inserted into the displaceable carrier.

### BACKGROUND OF THE INVENTION

1. Field of the Invention

The invention pertains to a processing center for round workpieces,

2. Prior Art

When manufacturing essentially rotationally symmetrical workpieces, it is common practice to utilize lathes in which the rotational cutting movement is carried out by the workpiece and the advance movement is carried out by the tool and/or vice versa. In numerically controlled automatic lathes, so-called inclined-bed machines are frequently utilized, wherein the support that carries the tools is arranged on an inclined guide surface of the machine bed. Tool carrier systems that, for example, are realized in the form of star-type modules, turret modules or drilling and milling modules are provided for carrying out various processing steps with different tools. Smaller processing units for carrying out certain milling or drilling processes can also be used in carrier systems of this type. However, the movements of such tool carrier systems are limited due to the risk of collisions with the workpieces. Due to the interfering contours of the processing units, a series of processing operations can, if at all, only be carried out with considerable expenditure. This is the reason why many concepts for broadening the processing spectrum consist of compromise solutions that are specifically adapted to one special application.

### SUMMARY OF THE INVENTION

The invention is based on the objective of developing a processing system of the initially described type which makes it possible to completely process round workpieces that are clamped in position only once.

This objective is attained with a processing center that is realized in accordance with the characteristics of a processing center for round workpieces that has a machine bed, a horizontal main driving spindle with a workpiece clamping device which is rotationally supported on the machine bed in a lateral headstock and rotationally driven by a drive, a tailstock arranged on the machine bed, and a support that is displaceably arranged on the machine bed, characterized by the fact that the support contains a table saddle that can be displaced on the machine bed and an upper headstock that is obliquely arranged on the table saddle and comprises a carrier that can be displaced along the longitudinal axis of the upper headstock, wherein exchangeable processing units for carrying out different processing technologies can be inserted into said carrier.

The processing center according to the above can be characterized by the fact that the upper headstock is arranged on the side of the upwardly beveled table saddle that can be displaced along a first linear axis, namely such that it can be displaced along a second linear axis that extends at an angle referred to the horizontal. Further, it can be characterized by the fact that the carrier is arranged in the upper headstock such that it can be displaced in a motor-driven fashion along a third linear axis that extends perpendicular to the first and the second linear axis. Additionally it can be characterized by the fact that a spindle, which is rotationally driven by a motor and serves for driving processing units, does not contain a separate drive that is arranged in the carrier. Also, the carrier can be realized in the form of a sleeve-shaped die. The one-part machine bed can consist of a stepped bed with a front bed section and an elevated, horizontal rear bed section. The table saddle can be displaceably arranged on the elevated rear bed section of the machine bed.

The processing center can comprise a chip conveyor for automatically carrying off chips accumulating during the processing of the workpiece is integrated into the machine bed. Still further, the drive of the main driving spindle can be realized in the form of a rotary drive, a position drive and a CNC-controlled circular milling drive. Also, the drive of the main driving spindle may contain one or two parallel driving motors and one respective switchable gear per driving motor. The processing center according to the above can be characterized by the fact that the processing units can be exchanged in accordance with the pick-up principle by displacing the support. If desired, the processing center can be characterized by the fact that a magazine for storing several processing units is arranged at the end of the machine bed on the tailstock side. The processing center can be provided with a device for automatically exchanging tools is arranged at the end of the machine bed on the tailstock side. The device for automatically exchanging tools can contain a tool magazine and an automatic tool exchanger. Also, the processing center can be characterized by the fact that the processing center contains a work space encapsulation that separates the guides, the tool exchanger, the pick-up station and the headstock from the work space.

Summarizing, the invention pertains to a processing center for round workpieces with a machine bed, a horizontal main driving spindle, with a workpiece chuck which is rotationally supported on the machine bed in a lateral headstock and rotationally driven by a drive, a tailstock that is arranged on the machine bed and a support that is displaceably arranged on the machine bed. The support contains a table saddle that can be displaced on the machine bed and an upper headstock that is obliquely arranged on the table saddle and contains a carrier that can be displaced along the longitudinal axis of the upper headstock. Exchangeable processing units for carrying out different processing technologies can be inserted into the displaceable carrier.

The processing center according to the invention is characterized by a broad application spectrum while simultaneously providing high static and dynamic rigidity. In addition to classic cutting processes, a series of other processing technologies, e.g., milling, drilling, circular milling, ⅚ axis processing, thread milling, deep-drilling, gear cutting, and, in particular, grinding, can also be carried out in a highly accurate fashion in only one clamped position of the workpiece. This makes it possible to completely process larger and complexly shaped round and asymmetric workpieces without requiring the respective workpiece to be clamped in a different position. The ability to easily exchange the different processing units ensures a high productivity and an optimal yield. The modular design also makes it possible to subsequently expand the unit by adapting corresponding processing units. A machine that was originally intended for different processing tasks can thus be expanded with new technologies.

Another significant advantage of the machine concept according to the invention can be seen in the optimized method for carrying off the chips. Chips accumulating during the processing of the workpiece are able to freely drop to the ground and do not become trapped on movable support elements or corresponding covers. In one advantageous embodiment, an automatic chip conveyor is integrated into the machine bed in order to carry off the chips dropping from the machine.

The carrier that accommodates the different processing units is, according to one particularly practical embodiment, realized in the form of a sleeve-shaped die. This carrier is situated in an obliquely arranged headstock unit that can be displaced on the bed on a displaceable sled-shaped carrier unit. The die can be displaced within the upper headstock transversely downward in the direction of the tool in accordance with the commands of an NC control. This ensures that the work space around the processing module is optimally cleared and the risk of collisions is reduced. A motor-driven driving spindle is arranged in the sleeve-shaped die. This makes it possible to drive the different processing units by means of a central unit if they do not contain a separate drive (motor spindles).

In one particularly solid and dimensionally rigid embodiment, the machine bed is realized in the form of a stepped bed with a front bed section and an elevated rear bed section. This makes it possible to also process large and heavy workpieces in a highly accurate fashion.

The drive of the main spindle is, according to another practical embodiment, realized with the aid of one or two parallel driving motors. This makes it possible to optimally adapt the drive to different power requirements. The drive is realized in the form of a rotary, position and circular milling drive.

In another embodiment, a magazine for the processing units used on the respective workpiece is arranged on the front bed section, namely at the end of the machine bed. This makes it possible to exchange the processing units in accordance with the pick-up method, wherein the support carries out simple traversing movements.

In order to realize a rapid and efficient automated exchange of the tools, a tool magazine with a corresponding automatic tool exchanger is also provided at the end of the machine.

### BRIEF DESCRIPTION OF THE DRAWINGS

Other details and advantages of the invention are discussed below in the description of one preferred embodiment that is referenced to the figures. Shown are:

FIG. 1, a schematic perspective representation of the entire processing center for round workpieces according to the invention;

FIG. 2, the basic design of the processing center shown in FIG. 1 in the form of a front view, a side view and a top view, and

FIG. 3, various processing units for carrying out different processing technologies on a round workpiece.

### DETAILED DESCRIPTION OF A PREFERRED EMBODIMENTS

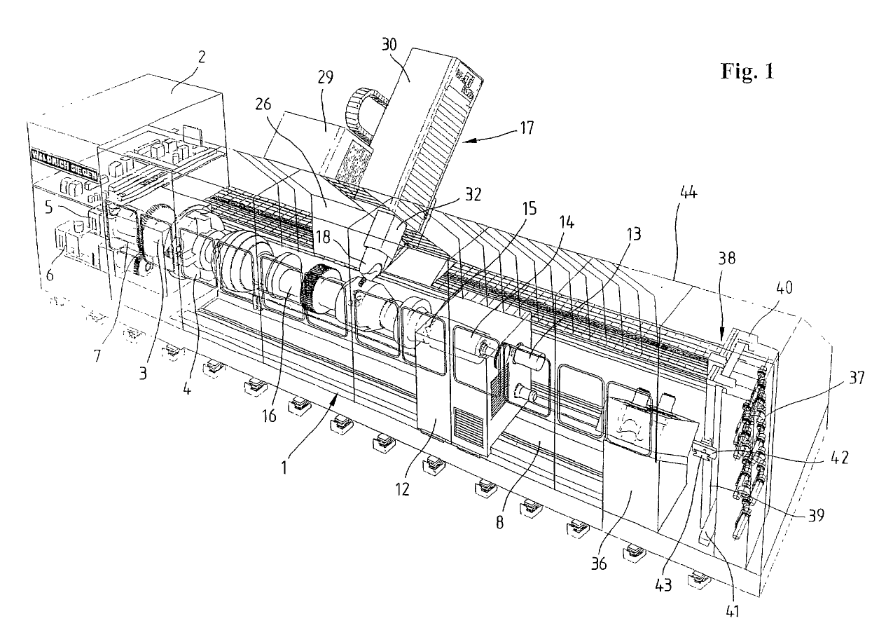

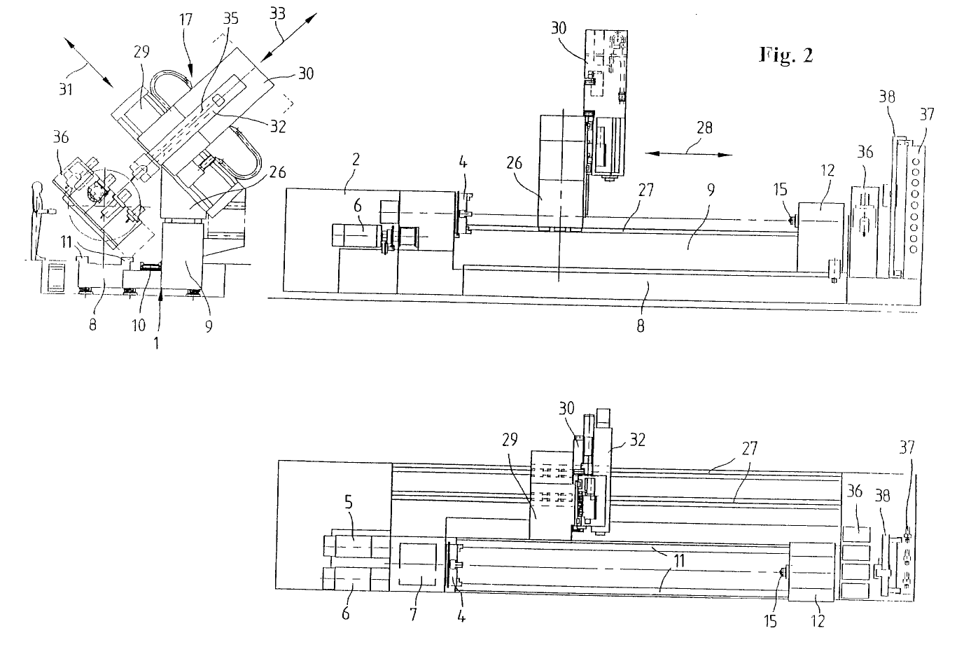

The processing center for round workpieces which is schematically illustrated in FIGS. 1 and 2 contains a machine bed 1 and a headstock 2, in which a horizontal workpiece driving spindle 3 with a workpiece clamping device 4 in the form of an end face chuck is rotatably supported. The drive of the workpiece driving spindle 3 is realized with the aid of one or two parallel driving motors 5 and 6, namely via one respective switchable two-stage planetary gear 7 that ensures a high operational reliability and an optimally quiet operation. The drive can be optimally adapted to the machine by providing the machine with one or two driving motors 5 and 6 in the form of rotary current motors. The drive is designed in such a way that it can be used as a rotary drive, as well as a position drive and a circular milling drive.

FIG. 2, in particular, shows that the machine bed 1 is realized in the form of a one-part stepped bed with a front bed section 8 and an elevated rear bed section 9. A chip conveyor 10 for automatically carrying off the chips accumulating during the processing of the workpiece is integrated into the machine bed 1 between the front bed section 8 and the rear bed section 9. The front bed section 8 contains two parallel guide tracks 11, on which a tailstock 12 can be adjusted along a longitudinal horizontal axis in a motor-driven fashion. A sleeve 14 that is adjustable in the longitudinal direction by means of a motor 13 is arranged in the tailstock housing. An axle is arranged in the sleeve and revolves with the rotational speed of the workpiece, wherein the tailstock tip 15 is inserted into said axle. A workpiece 16 to be processed is clamped between the chuck 4 and the tailstock tip 15. The mechanical adjustment of the tailstock 12 and the sleeve 14 ensure that the workpiece is rapidly and reliably received. The sleeve design allows a sensitive adjustment of the approach of the tailstock to the workpiece such that workpieces that have a lesser axial rigidity can also be truly clamped in position. A spring assembly is also integrated into the sleeve in order to compensate length changes of the workpiece, e.g., due to varying temperature.

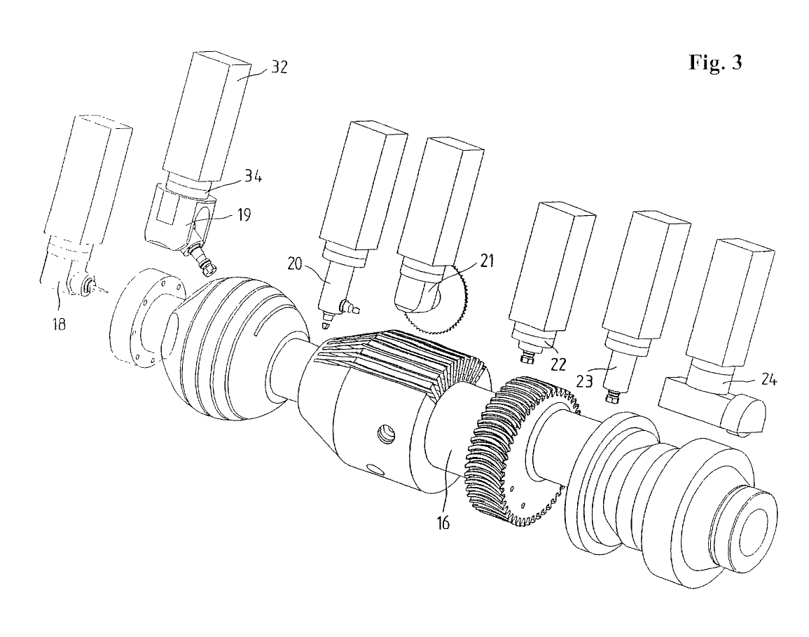

A support 17 with a headstock for receiving a series of different processing units 18-24, shown in FIG. 3, is arranged on the rear bed section 9. Different processing technologies, e.g., milling, cutting, circular milling, drilling, ⅚ axis processing, thread milling, deep-drilling, gear cutting and even grinding can be carried out with the aid of these processing units.

FIG. 2, in particular, shows that the support 17 contains a table saddle 26 that can be displaced in a motor-driven fashion on the upper side of the rear bed section 9 along a first linear axis 28 (Z-axis) that extends parallel to the longitudinal axis of the workpiece by means of guides 27. An upper headstock 30 is arranged on the side of an upper part 29 of the table saddle 26 which is bent upward by 45°, namely such that it can be displaced in a motor-driven fashion along the second linear axis 31 (Y-axis) that is inclined relative to the horizontal by 45°. A carrier 32 that is realized similar to a die is guided in the headstock 30 such that it can be displaced transverse to the workpiece in a third linear axis 33 (X-axis) that extends perpendicular to the two linear axes 28 and 31. An interface 34 is provided on the front end of the carrier 32, with said interface not only ensuring that the different processing units are reliably held in position, but also that said processing units can be optimally supplied with different mediums. A spindle 35 that is rotationally driven by a motor is arranged in the rectangular carrier 32, with said spindle driving the different processing units if they are not provided with a separate drive.

FIG. 3 shows a few examples of processing units, as well as the corresponding processing results on a turned part 16. On the left side, an angled drilling and cutting unit 18 is shown. For example, this unit makes it possible to produce bores in the end face of the turned part 16. A processing unit 19 for carrying out a ⅚ axis processing is shown adjacent to the drilling and cutting unit 18. This processing unit contains a pivoted part that can be pivoted about an additional axis of rotation and is accommodated in a fork-shaped holding arrangement. This additional axis makes it possible to also produce complex tracks on curved surfaces. Surfaces that are inclined at arbitrary angles in space can also be processed in connection with another axis of rotation about the longitudinal axis of the die-shaped carrier. A milling unit 20 with an end face holding arrangement and a lateral holding arrangement for receiving tools of modular tool systems is shown adjacent to the previously described processing unit. For example, longitudinal, planar and contour milling operations can be carried out with this milling unit 20. Adjacent to the milling unit 20, a cutting unit 21 with a disk milling cutter is shown. This disk milling cutter makes it possible, for example, to produce the slots shown on the outside of the turned part 16. In addition, a straight milling cutter unit 22 and a milling cutter unit 23 provided with a motor spindle are shown. Complex gears can also be cut, for example, by turning the main driving spindle in a controlled fashion. The processing units may also contain rapidly revolving attachment spindles for realizing high-speed operation. A grinding unit that, in contrast to conventional processing centers, also makes it possible to carry out grinding processes is shown on the right.

In order to automatically exchange the respective processing units, a magazine 36 containing the processing units is arranged at the end of the front bed section 8 in the side view shown in FIG. 2. The processing units are arranged in this magazine 36 at an angle of 45° in such a way that they can be easily picked up or deposited by the carrier 32 after the support 17 is correspondingly displaced. In the embodiment shown, the magazine 36 that can be expanded in a modular fashion is stationarily arranged at the end of the machine bed 1. However, it could also be displaceably arranged on the guide tracks 11 of the front bed section 8. This would shorten the distance to be traveled by the table saddle 26 for realizing a tool exchange if shorter workpieces are predominantly processed.

In order to realize a fast and efficient exchange of the tools, a device for automatically exchanging the tools is arranged laterally from the magazine 36 for accommodating the processing units. This device consists of a tool magazine 37 and a tool exchanger 38 for transporting the tools between the tool magazine 37 and a processing unit 18 arranged in the carrier 32. The tool exchanger 38 contains a vertical support 39 that is arranged such that it can be displaced transverse to the longitudinal axis of the machine bed 1 by means of upper and lower guide rails 40 and 41. A slide 42 is guided on the support 39 such that it can be displaced along the vertical axis. The slide 42 carries the tool gripper 43 that it is realized in the form of a double-gripper and makes it possible to exchange the tool clamped in the processing unit 18 with a tool situated in the tool magazine 37. The tool magazine 37 is realized in the form of a shelf magazine that is arranged in a space-saving fashion at the end of the processing center along an extension of the machine bed 1 and can be arbitrarily expanded. It would also be conceivable to arrange the tool exchanging device on the guide tracks 11 of the front bed section 8 in a displaceable fashion.

Back rests may be arranged on the front bed section 8 for support purposes in order to prevent particularly long and slim workpieces from bending. A particularly high accuracy can be achieved with NC-controlled back rests that can be adjusted in a controlled fashion along all axes. In a basic variation, the back rests may be realized in the form of roller-type back rests. For certain applications, the back rests may be realized in the form of hydrodynamic or hydrostatic back rests with synchronously or individually adjustable supports.

The work space encapsulation 44 that is schematically illustrated in FIG. 1 covers the work space in such a way that all support guides are situated outside the work area. Due to this measure, these guides are protected from becoming soiled such that their wear can simultaneously be minimized.

Although the invention is shown and described in terms of preferred embodiments, changes and modifications will be evident to those skilled in the art that do not depart from the teachings herein. Such changes and modifications are deemed to fall within the purview of the inventions as claimed.

1. Processing center for round workpieces, with a machine bed, a horizontal main driving spindle with a workpiece clamping device which is rotationally supported on the machine bed in a lateral headstock and rotationally driven by a drive, a tailstock arranged on the machine bed, and a support that is displaceably arranged on the machine bed, characterized by the fact that the support contains a table saddle that can be displaced on the machine bed and an upper headstock that is obliquely arranged on the table saddle and comprises a carrier that can be displaced along the longitudinal axis of the upper headstock, wherein exchangeable processing units for carrying out different processing technologies can be inserted into said carrier.

2. Processing center according to claim 1, characterized by the fact that the upper headstock is arranged on the side of the upwardly beveled table saddle that can be displaced along a first linear axis, namely such that it can be displaced along a second linear axis that extends at an angle referred to the horizontal.

3. Processing center according to claim 2, characterized by the fact that the carrier is arranged in the upper headstock such that it can be displaced in a motor-driven fashion along a third linear axis that extends perpendicular to the first and the second linear axis.

4. Processing center according to claim 1, characterized by the fact that a spindle which is rotationally driven by a motor and serves for driving processing units that do not contain a separate drive is arranged in the carrier.

5. Processing center according to claim 1, characterized by the fact that the carrier is realized in the form of a sleeve-shaped die.

6. Processing center according to claim 1, characterized by the fact that the one-part machine bed consists of a stepped bed with a front bed section and an elevated, horizontal rear bed section.

7. Processing center according to claim 6, characterized by the fact that the table saddle is displaceably arranged on the elevated rear bed section of the machine bed.

8. Processing center according to claim 1, characterized by the fact that a chip conveyor for automatically carrying off chips accumulating during the processing of the workpiece is integrated into the machine bed.

9. Processing center according to claim 1, characterized by the fact that the drive of the main driving spindle is realized in the form of one of a rotary drive, a position drive and a CNC-controlled circular milling drive.

10. Processing center according to claim 1, characterized by the fact that the drive of the main driving spindle contains one or two parallel driving motors and one respective switchable gear per driving motor.

11. Processing center according to claim 1, characterized by the fact that the processing units can be exchanged in accordance with the pick-up principle by displacing the support.

12. Processing center according to claim 1, characterized by the fact that a magazine for storing several processing units is arranged at the end of the machine bed on the tailstock side.

13. Processing center according to claim 1, characterized by the fact that a device for automatically exchanging tools is arranged at the end of the machine bed on the tailstock side.

14. Processing center according to claim 13, characterized by the fact that the device for automatically exchanging tools contains a tool magazine and an automatic tool exchanger.

15. Processing center according to claim 1, characterized by the fact that the processing center contains a work space encapsulation that separates the guides, the tool exchanger, the pick-up station and the headstock from the work space.
